(19) United States
(12) Patent Application Publication
(10) Pub. No.: US 2024/0341526 A1
(43) Pub. Date: Oct. 17, 2024

(54) MODULAR, PORTABLE, BATTERY-POWERED COOKTOP

(71) Applicant: Joseph Ganahl, Honolulu, HI (US)

(72) Inventor: Joseph Ganahl, Honolulu, HI (US)

(21) Appl. No.: 18/755,650

(22) Filed: Jun. 26, 2024

Related U.S. Application Data
(63) Continuation-in-part of application No. 18/375,919, filed on Oct. 2, 2023.
Application No. 18/375,919 is a continuation-in-part of application No. 17/838,138, filed on Jun. 10, 2022.
Application No. 17/838,138 is a continuation of application No. 17/536,049, filed on Nov. 28, 2021.
Application No. 17/536,049 is a continuation-in-part of application No. 16/459,795, filed on Jul. 2, 2019, now abandoned.
(63) Continuation-in-part of application No. 18/375,898, filed on Oct. 2, 2023.
(63) Continuation-in-part of application No. 18/426,188, filed on Jan. 29, 2024.

(51) Int. Cl. A47J 36/24; A23L 3/28; A47J 36/02; A47J 36/10; A47J 36/38; A47J 47/14

(52) U.S. Cl. CPC A47J 36/2483; A23L 3/28; A47J 36/025; A47J 36/10; A47J 36/38; A47J 47/14

(57) ABSTRACT

The embodiments disclose a portable battery powered cooktop, including a heat plate, a control printed circuit board assembly coupled to heating elements of the heating device configured to regulate current and send the current to the heat plate via the heating elements, at least one removable rechargeable battery pack with a heat resistance housing configured to withstand a predetermined operating temperature of the at least one removable rechargeable battery pack, a temperature control device coupled to the control printed circuit board assembly and configured to regulate a temperature of the heat plate, wherein the control printed circuit board assembly is configured to activate and control the temperature of the heating elements to warm and cook food on the heat plate and a vented air buffer chamber located within the heating device and configured to dissipate heat between the heat plate and the at least one removable rechargeable battery pack.

### CROSS-REFERENCE TO RELATED APPLICATIONS

This Patent Application is a Continuation-In-Part and claims priority to the United States Patent Application entitled: “TRANSPORTABLE FOOD WARMING MODULE METHOD AND DEVICES”, U.S. Ser. No. 18/375,919 filed on Oct. 2, 2023, by Joseph Ganahl, which is a Continuation-In-Part of United States Patent Application entitled: “TRANSPORTABLE FOOD WARMING MODULE METHOD AND DEVICES”. U.S. Ser. No. 17/838,138 filed on Jun. 10, 2022, by Joseph Ganahl, which is a Continuation of United States Patent Application entitled: “FOOD WARMING SYSTEM”, U.S. Ser. No. 17/536,049 filed on Nov. 28, 2021, by Joseph Ganahl, which is a Continuation-In-Part of United States Patent Application entitled: “FOOD WARMING SYSTEM”, U.S. Ser. No. 16/459,795 filed on Jul. 2, 2019, by Joseph Ganahl, which claims priority to U.S. Provisional Patent Application Ser. No. 62/694,981 filed Jul. 7, 2018, entitled “FOOD WARMING SYSTEM”, by Joseph Ganahl, this Patent Application is also a Continuation-In-Part and claims priority to United States Patent Application entitled: “FOOD WARMING SYSTEM”, U.S. Ser. No. 18/375,898 filed on Oct. 2, 2023, by Joseph Ganahl, this Patent Application is also a Continuation-In-Part of and claims priority to United States Patent Application entitled: “TRANSPORTABLE TEMPERATURE CONTROL MODULE SYSTEM FOR FOOD, BEVERAGE, PHARMACEUTICALS AND MEDICAL”. U.S. Ser. No. 18/426,188 filed on Jan. 29, 2024, by Joseph Ganahl, all of the above being incorporated herein by reference.

### BACKGROUND

Cooking and heating food is a part of everyday life. Many American meals are consumed in a car. Also, many Americans enjoy outdoor activities; and open fire cooking is not allowed in many outdoor locations. This means lots of Americans use their food budgets on prepared meals. Dining trends are changing rapidly with consumers desiring healthy meals that are fast and convenient.

### FIELD OF THE INVENTION

The present invention is generally directed to a portable, battery-powered device for heating prepared meals and cooking food. In one embodiment, the present invention can be used for heating prepared meals, which allows rapid, quick on the go food. In another embodiment, a high-capacity, removable battery can be attached to the device as a watertight power bank. The present invention includes one or more removable attachable power source modules.

### BRIEF DESCRIPTION OF THE DRAWINGS

FIG. 1A shows for illustrative purposes only an example of a meal heating system of one embodiment.

FIG. 1B shows for illustrative purposes only an example of an uncovered meal heating system of one embodiment.

FIG. 2 shows for illustrative purposes only an example of a removable battery installed in the bottom of a meal heating system of one embodiment.

FIG. 3 shows for illustrative purposes only an example of a portable cooking system of one embodiment.

FIG. 4 shows for illustrative purposes only an example of an exploded view of a cooking system of one embodiment.

FIG. 5A shows for illustrative purposes only an example of a cookware mounting bracket of one embodiment.

FIG. 5B shows for illustrative purposes only an example of cookware installed on the cooking system of one embodiment.

FIG. 6 shows for illustrative purposes only an example of a high-capacity battery connecting to a power bank conversion cover with port covers closed of one embodiment.

FIG. 7A shows for illustrative purposes only an example of a front view of the power bank conversion cover with port covers open of one embodiment.

FIG. 7B shows for illustrative purposes only an example of O-rings on connection cables for the watertight fitting of one embodiment.

FIG. 8 shows for illustrative purposes only an example of a temperature control system digital application of one embodiment.

FIG. 9 shows for illustrative purposes only an example of a temperature control of one embodiment.

FIG. 10 shows for illustrative purposes only an example of a cover food ready alert LED of one embodiment.

FIG. 11A shows for illustrative purposes only an example of a wireless system of one embodiment.

FIG. 11B shows for illustrative purposes only an example of recharging systems of one embodiment.

FIG. 12 shows for illustrative purposes only an example of a temperature control of one embodiment.

FIG. 13 shows for illustrative purposes only an example of a food warming system digital application of one embodiment.

FIG. 14 shows for illustrative purposes only an example of a hot bento box app of one embodiment.

### DETAILED DESCRIPTION OF THE INVENTION

In the following description, reference is made to the accompanying drawings, which form a part hereof, and which are shown by way of illustration a specific example in which the invention may be practiced. It is to be understood that other embodiments may be utilized, and structural changes may be made without departing from the scope of the present invention.

### General Overview

It should be noted that the descriptions that follow, for example, in terms of portable, battery-powered cooktop methods and devices are described for illustrative purposes and the underlying system can apply to any number and multiple types of food preparation processes. In one embodiment of the present invention, the portable, battery-powered cooktop method and devices includes a heat plate that can be coupled to heating elements configured to warm leftovers or prepare meals on the heat plate. In another embodiment, the portable, battery-powered heat plate can be configured to heat and cook food at temperatures up to and above 500° F. The portable, battery-powered cooktop method and devices can include a watertight cover. In another embodiment, food pans and other cookware can be used to contain food that can be heated and cooked on top of the heat plate. This device and method can also be configured to transport food with 12 v vehicle power using the present invention.

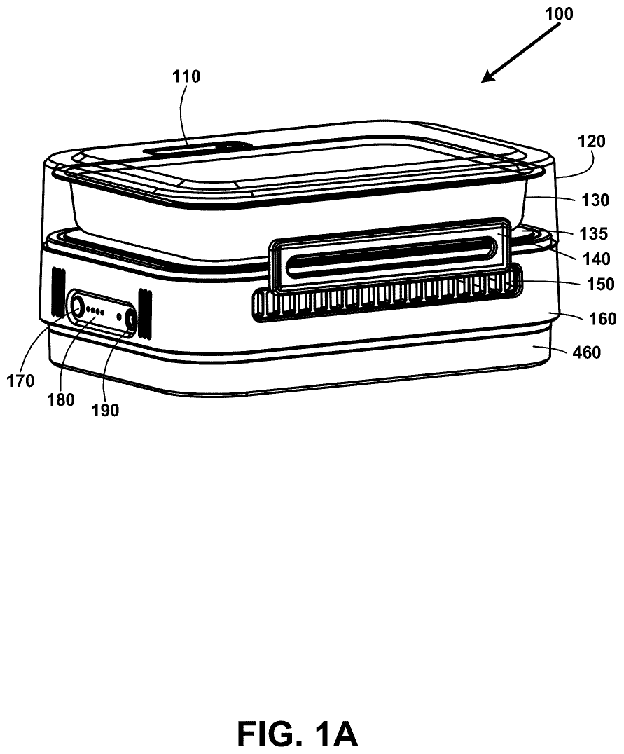

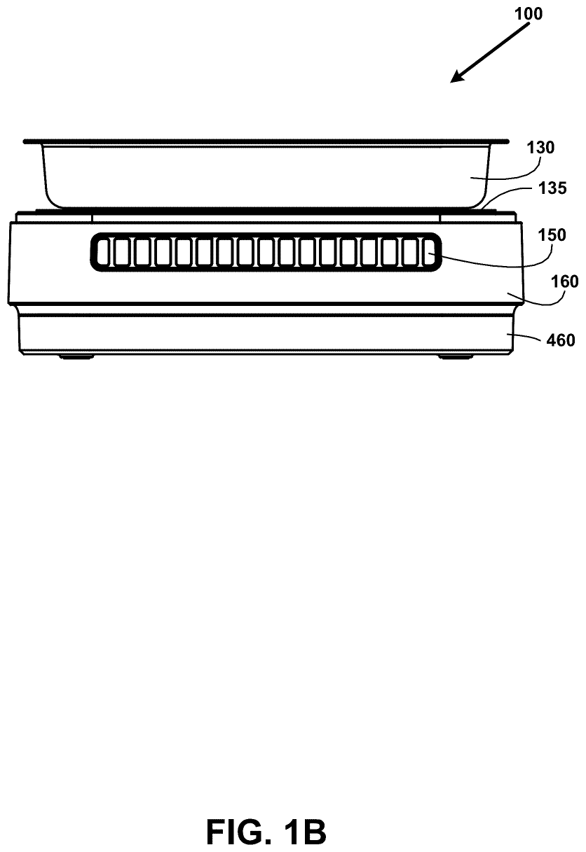

FIG. 1A shows for illustrative purposes only an example of a meal cooking and heating system of one embodiment. FIG. 1A shows a portable battery powered cooktop as a meal heating system 100 with a meal cover 120 including pressure vent 110, removable meal tray 130 on top of a heat plate 135, cover clip 140, air buffer vent 150, a heating device 160 with LED indicators 180, power input port 190, power button 170, and a high temperature/high-capacity battery 460.

The meal heating system 100 contributes to a substantial benefit for new food preparation methods. A portable, battery-powered food heating and cooking system will have an impact on meal prep, dietary health, and food safety.

FIG. 1B shows for illustrative purposes only an example of an uncovered meal heating system of one embodiment. FIG. 1B shows an example of a side view of meal heating system 100, with removable meal tray 130, heat plate 135, air buffer vent 150, heating device 160, and high temperature/high-capacity battery 460 of one embodiment.

### DETAILED DESCRIPTION

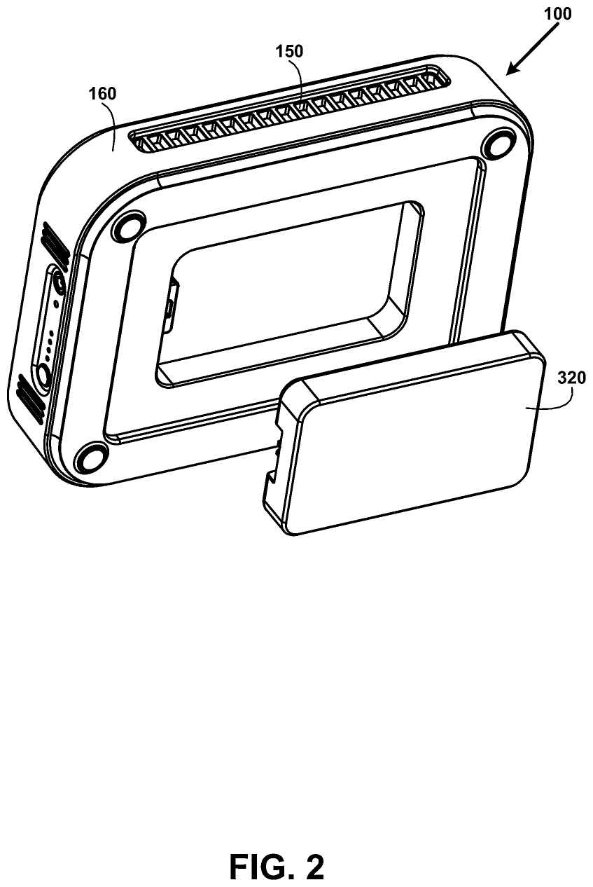

FIG. 2 shows for illustrative purposes only an example of a removable battery installed in the bottom of a meal heating system of one embodiment. FIG. 2 shows a bottom view of the meal heating system 100 with a compact removable battery 320. The meal heating system 100 with a compact removable battery 320 snaps into the bottom of the device. The meal heating system 100 is configured to reheat meals that have already been cooked. These can be leftovers placed in a reusable, removable aluminum tray or disposable packaging tray for ready meals. The meal heating system 100 can also cook meals.

The removable meal tray 130 of FIG. 1A is placed on top of the heat plate 135 of the meal heating system 100. The meal cover 120 of FIG. 1A is positioned to form a watertight seal and hold the removable meal tray 130 of FIG. 1A in place with an O ring inside the meal cover 120 of FIG. 1A. The cover clips 140 of FIG. 1A lock the meal cover 120 of FIG. 1A in place.

When the power button 170 of FIG. 1A is pressed, it activates energy flow from the high temperature/high-capacity battery 460 of FIG. 1A to the heat plate 135. In one embodiment, medium-level heat is supplied for a set time, usually 15-20 minutes. Other embodiments may use a different combination of time and temperature. The heat is controlled to warm already-cooked food for eating. The LED indicators 180 of FIG. 1A shows the available battery power level, and the charging port can be used to recharge the high-temperature/high-capacity battery 460 of FIG. 1A.

Using an optional AC will supply power to the device and allow unlimited warming or low-level cooking capability. The AC is plugged into the same port as a charging adapter in one embodiment. Other embodiments may have separate ports for each AC device.

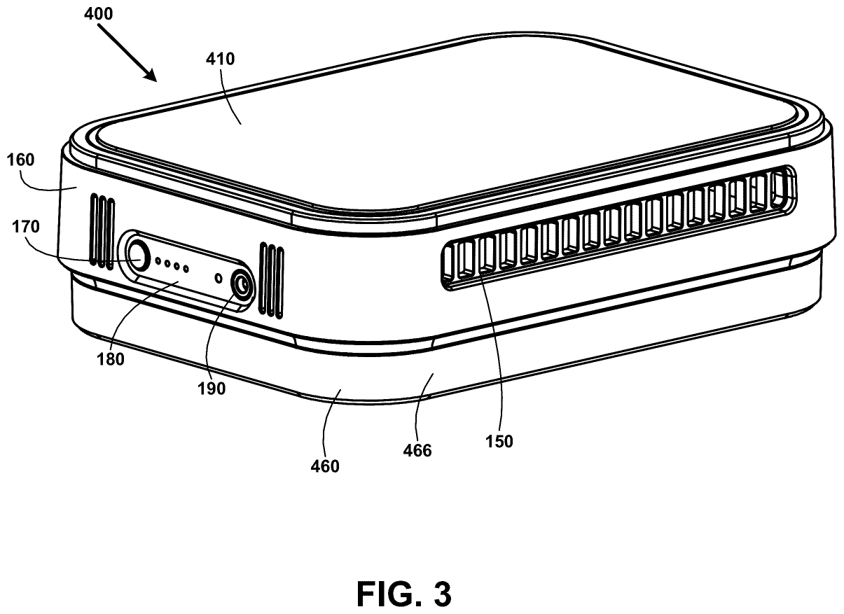

The high-temperature/high-capacity battery 460 of FIG. 1A can be recharged on the device via the charging port or off the device via a dedicated charge port. Recharging can be done via AC, 12 v car/marine, solar, or other power sources. The high temperature/high-capacity battery 460 of FIG. 1A itself and the main device PCBA 466 of FIG. 3 contain multiple safety circuits to control charging and discharging.

FIG. 3 shows for illustrative purposes only an example of a portable cooking system of one embodiment. FIG. 3 shows a portable, battery-powered cooking device. Shown are the cooking system 400 with heat plate 410, which is similar to heat plate 135 of FIG. 1A and FIG. 1B, air buffer vent 150, power button 170, LED indicators 180, power input port 190, and high temperature/high-capacity battery 460.

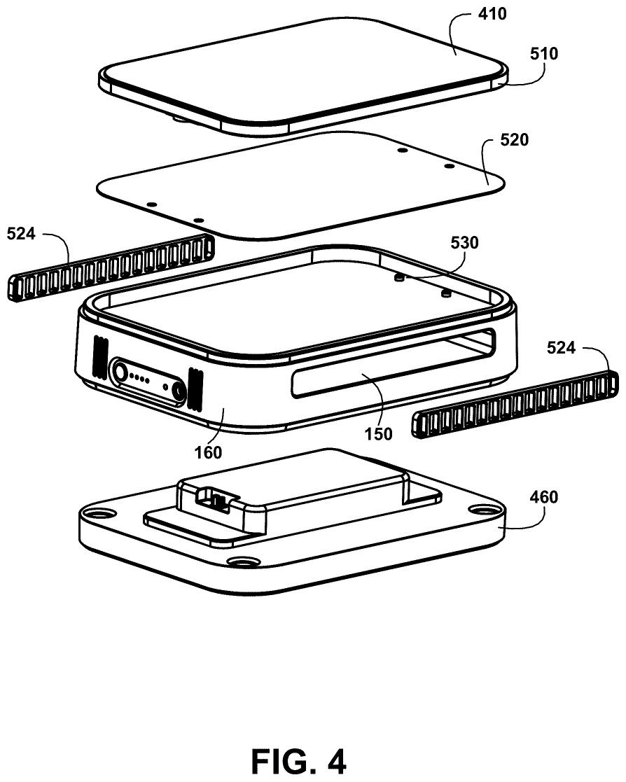

FIG. 4 shows for illustrative purposes only an exploded view of the portable cooking device of one embodiment. FIG. 4 shows an exploded view of the portable cooking device with the heat plate 410, encased in heat resist plastic 510, with conductive contacts 530, thermal insulation 520, air buffer vent 150, protective grill 524, and high temperature/high-capacity battery 460. Wherein the conductive contacts 530 are also referred to herein as heating elements that have heat dispensing capabilities.

The power button 170 of FIG. 1A activates the system when it is single-pressed, and also controls temperature settings when double-pressed. In one example, a plurality of LED power indicators 180 of FIG. 1A displays LED lights indicating battery level and in temperature selection mode-selected temperature. In one embodiment, when one LED is lit, this means the temperature is low. When two LEDs are lit, this means the temperature is low medium. When three LEDs are lit, this means the temperature is high and medium. When four LEDs are lit, this means the temperature is high, up to 500° F. or greater. In another embodiment, the battery level and temperature selection mode are indicated using a gauge meter showing the battery charge level and temperature selection mode shows a temperature as a series of lights along a bar screen with temperature readings. Other indicator components such as LED screens, can also be used for these functions.

The heat plate 410 is encased in high heat-resistant plastic 510 and nests on a bed of high heat-resistant, anti-flammable material. Between these materials is a layer of thermal insulation 520 material.

Pushing the Power button 170 of FIG. 1A activates the flow of current from the battery to PCBA 466 of FIG. 3. The PCBA 466 of FIG. 3 regulates current and sends it onward to the heat plate via the conductive contacts in one embodiment. In other embodiments, multiple conductive contacts may be utilized for alternative power supplies and temperature regulation.

High heat can be dangerous for batteries. Thus, the high-temperature/high-capacity battery 460 of FIG. 1A has a heat resistance housing that is configured to withstand a predetermined operating temperature. In addition, heat transfer devices, ventilation, spacing and air flow can be used to allow the high-temperature/high-capacity battery 460 of FIG. 1A to protect it from overheating due to heat from the heat plate 410. In one embodiment, the predetermined operating temperature is an operating temperature of approximately 182° F., which is about 30% higher than the industry average temperatures (140° F.) for these types of portable batteries. A relatively high current is used to drive cooking temperatures. In one embodiment, a proprietary mix of cells is arranged in series and parallel provides the necessary current levels.

The removable high-temperature/high-capacity battery 460 of FIG. 1A provides direct power to the device for fully portable and independent use. The battery can be recharged on the device via AC, 12 v car/boat power, solar power, and other power sources. It may be charged independently of the device by the same power sources via a dedicated charge port. The battery contains multiple safety circuits to control charging and discharging.

The proprietary air buffer vent 150 of FIG. 1A moves the battery further from the heat source and provides an insulative layer of air that is vented on all sides for maximum ventilation. In accordance with the laws of thermodynamics, heat moves from areas of higher temperature to areas of lower temperature. The hot air will vent out the sides and be replaced by cooler air, further adding to the insulative effect. The air buffer vent 150 of FIG. 1A is protected by a grid structure to prevent foreign objects from entering. In some embodiments, a fan may be added to air buffer vent 150 of FIG. 1A to further increase the airflow cooling effect.

The removable high-temperature high-capacity battery 460 of FIG. 1A provides direct power to the device for fully portable, independent, full-function cooking use. The battery can be recharged via AC, 12 v car/boat power, solar power, and other power sources.

The device can also be powered by a direct AC connection, bypassing the battery. AC power allows full-function cooking and can be connected via the charging port in one embodiment or a dedicated port in another embodiment. A 12 v car or marine power can be utilized for warming and transport, connected via the charging port in one embodiment or a dedicated port in another embodiment. 12 v is not high enough current for actual cooking but is quite useful for transporting cooked food and keeping it hot or serving cooked food and maintaining heat.

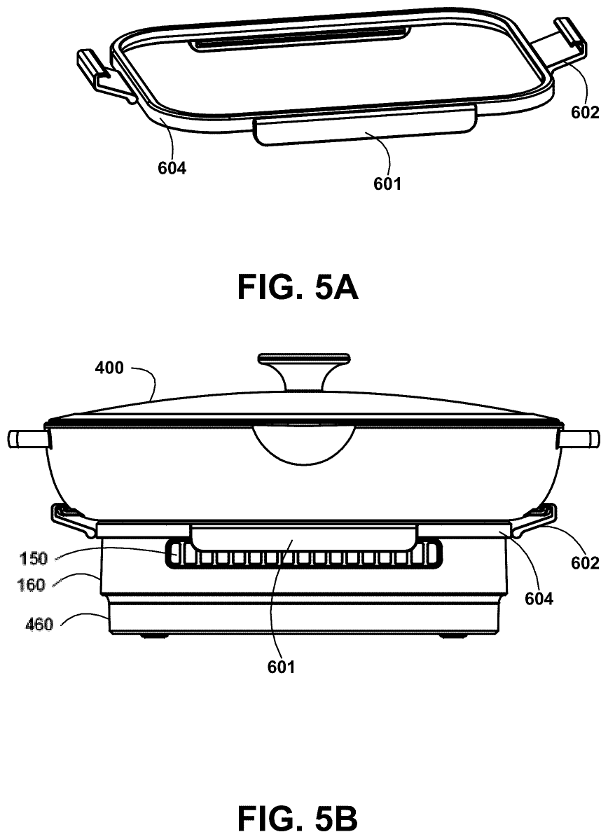

FIG. 5A shows for illustrative purposes only an example of a cookware mounting bracket of one embodiment. FIG. 5A shows a mounting bracket 602 with side clips 601 and cookware clips 602 of one embodiment.

FIG. 5B shows for illustrative purposes only an example of cookware installed on the cooking system of one embodiment. FIG. 5B shows cookware 400 mounted on the cooking system 630 with air buffer vent 150, high temperature/high-capacity battery 460, mounting bracket 604 side clips 601, and cookware clips 602.

The mounting bracket 604 attaches to the cooking system 630 by latching the side clips 601 in the same as the meal cover 120 of FIG. 1A. The cookware clips 602 attach to specially modified pots and pans to securely hold the cookware 400 in place atop the cooking system 630. The attachment system allows safe cooking in unsteady environments like a boat or RV. It is also beneficial for maintaining heat while transporting food.

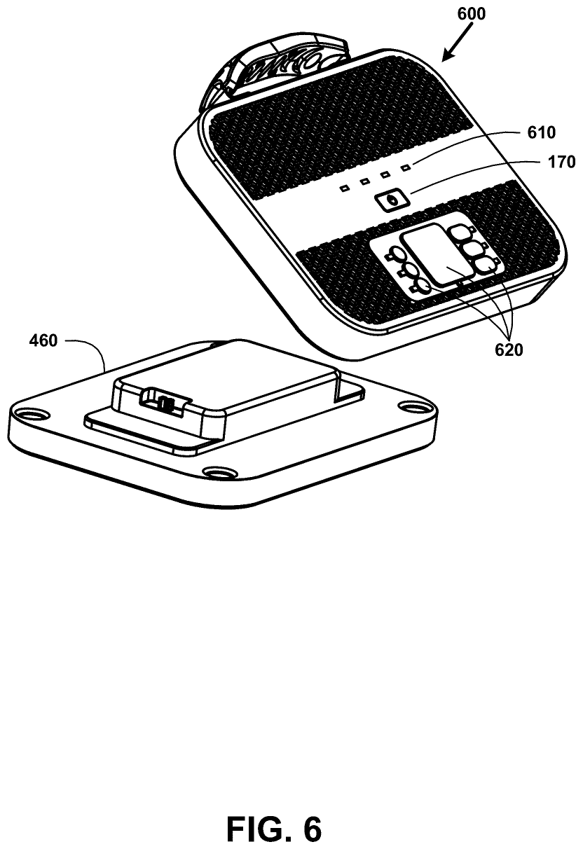

FIG. 6 shows for illustrative purposes only an example of a high-capacity battery connecting to a power bank conversion cover with port covers closed of one embodiment. FIG. 6 shows a watertight power bank cover of one embodiment. FIG. 6 shows a watertight power bank cover 600 attachable to the high-temperature/high-capacity battery 460. Also shown are the LED power level indicators 610, power button 170, and connection port watertight covers 620.

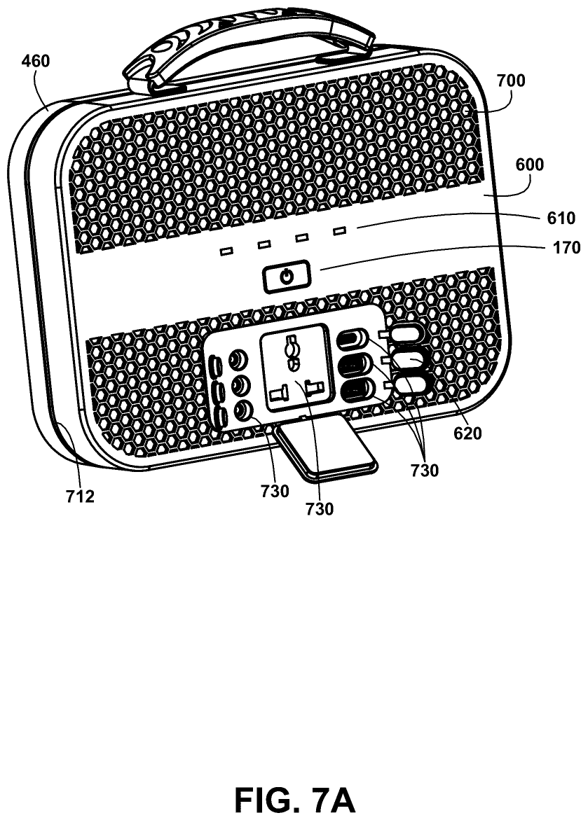

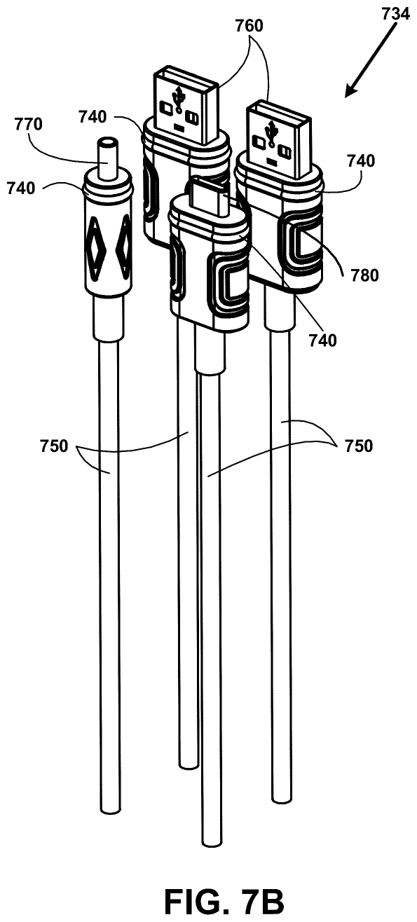

FIG. 7A shows for illustrative purposes only an example of a front view of a power bank conversion cover of one embodiment. FIG. 7A shows an example of a front view of power bank conversion cover 700, with LED power level indicators 610, power button 170, watertight connection ports 730, and connection port watertight covers 620.

The high temperature/high-capacity battery 460 can be utilized in alternative ways including conversion to a watertight power bank. The battery clips into the power bank conversion cover 600 are sealed with a watertight O ring 712. The port connections 730 on the front are sealed with connection port watertight covers 620 when not in use. The port connections 730 are recessed with a smooth entry channel sleeve. Connecting cables have O rings that seal in the entry channel sleeves for watertight connections. LED power level indicators 610 and power button 170 have a watertight design, so the entire device is sealed for use in wet environments of one embodiment.

FIG. 7B shows for illustrative purposes only an example of watertight O-ring cables of one embodiment. FIG. 7B shows examples of watertight O ring cables 734. The connection tips include a watertight O ring 740 to prevent liquid from contact with the power connections. An independent conductive cable 750 is connected to each USB connector 760, power plug 770, and type C connector 780 of one embodiment.

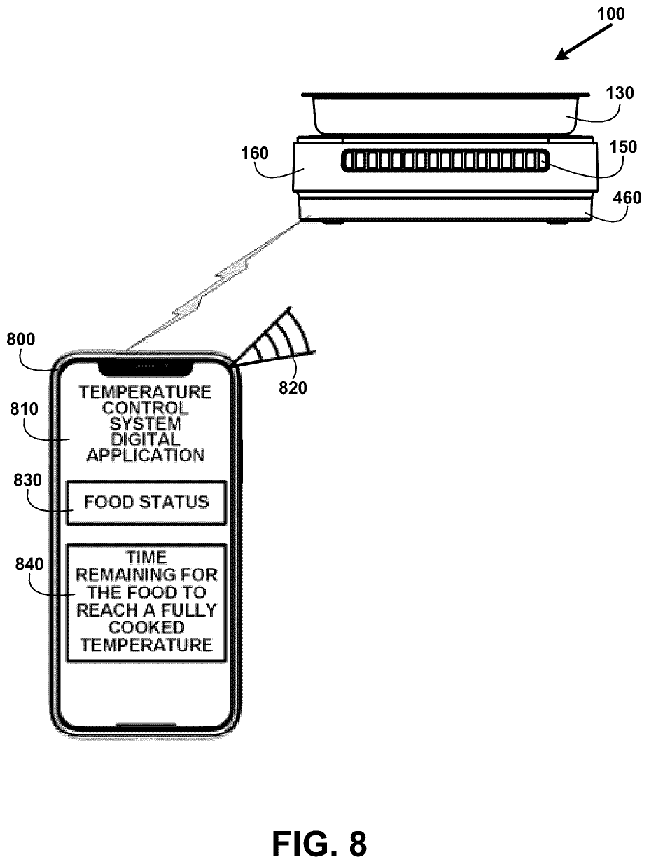

FIG. 8 shows for illustrative purposes only an example of a temperature control system digital application of one embodiment. FIG. 8 shows the modular, portable, battery-powered cooktop that includes a temperature control system digital application 810 for installation on a user's digital device 800 including, for example, a smartphone, tablet, laptop computer, and other digital devices. The temperature control system digital application 810 installed on a user's digital device 800 is configured for displaying food status 830 on a digital screen and broadcasting audible food status alerts 820. The user can tap the temperature control system digital application 810 icon and receive intermediate food status alerts 820 to check the current temperature and a calculated approximate time remaining for the food to reach a fully cooked temperature 840.

In one embodiment, the temperature control system digital application 810 digital application may display the temperature selection controls of the modular, portable, battery-powered cooktop digital application module. This allows the user to set the desired temperature via the user's digital device 800. The user may want to turn off or adjust the temperature which they can perform using the temperature control system digital application of one embodiment. In another embodiment, the modular, portable, battery-powered cooktop temperature control system digital application may include recipes with preset cooking instructions of one embodiment.

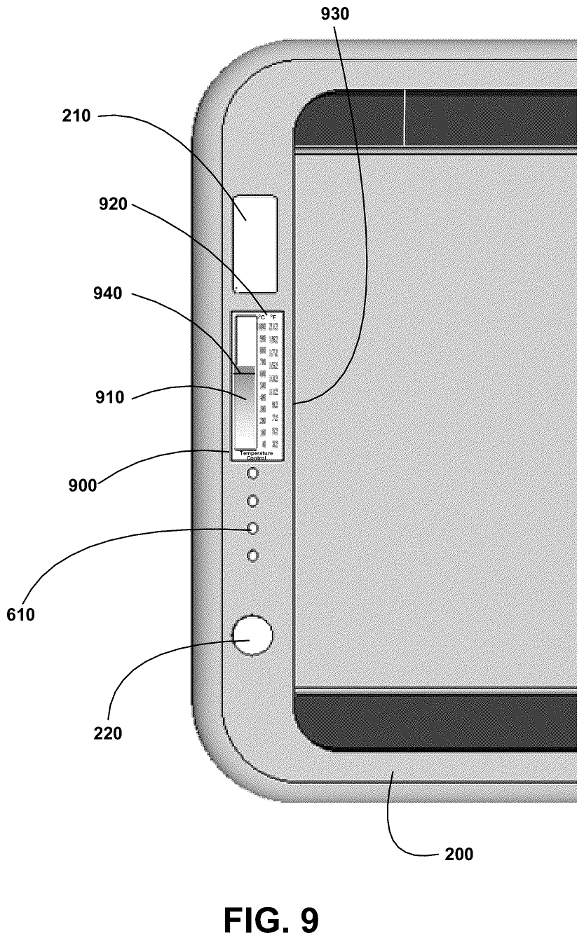

FIG. 9 shows for illustrative purposes only an example of a temperature control of one embodiment. FIG. 9 shows the heat tray insert 200, the waterproof power button 220; waterproof LED indicators 600, and the waterproof charge port cover 210. Also shown is a temperature control 900. The temperature control 900 is coupled to the control printed circuit board assembly (PCBA) 466 of FIG. 3. The temperature control 900 is configured for the user to set a temperature for warming the food placed in the food warming system.

The temperature control 900 includes a temperature setting touch screen slide 910 adjusting feature. The temperature setting touch screen slide 910 is adjustable using degrees Celsius and degrees Fahrenheit temperature scales 920. The temperature control 900 includes monitoring food temperature in real time using at least one infrared thermometer 930 that is coupled to the control printed circuit board assembly (PCBA) 466 of FIG. 3 and temperature control 900. The temperature setting touchscreen slide 910 includes a safe temperature limit 940 indicating line to remind the user not to set a temperature above that limit of one embodiment.

In another embodiment, the temperature control 900 includes digital touch buttons labeled for specific food types, for example, soups, sandwiches, stews, vegetables, and others. The digital touch buttons labeled for specific food types when pressed will set the targeted temperature setting to preset temperatures prerecorded in one of the at least one database.

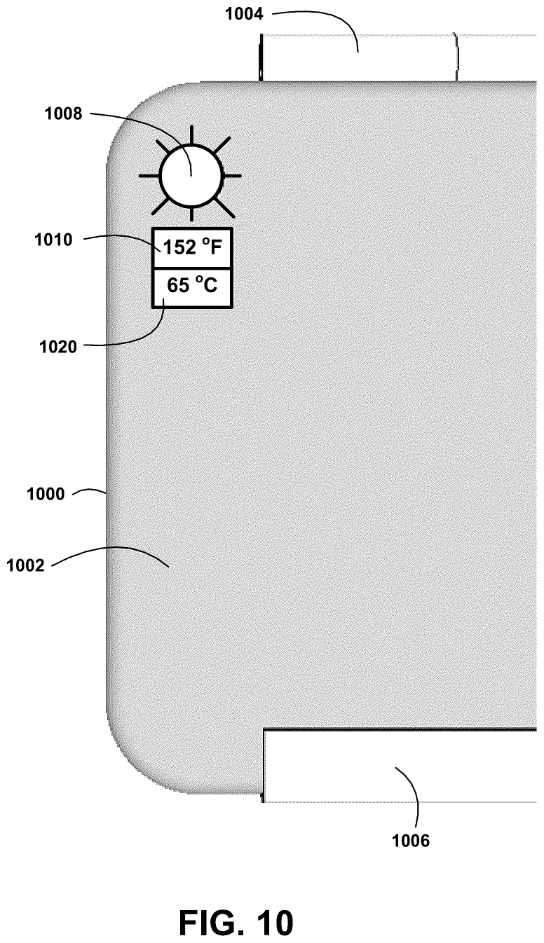

FIG. 10 shows for illustrative purposes only an example of a cover food ready alert LED of one embodiment. FIG. 10 shows the food container 1000 cover 1002, cover hinge 1004, and cover clasp 1006. In one embodiment, the cover 1002 includes a food ready alert LED 1008, a food temperature digital display in degrees Fahrenheit 1010, and a food temperature digital display in degrees Celsius 1020.

The food status audible alert broadcast 830 of FIG. 8 can be heard by a user with a visual impairment. The food ready alert LED 1000, food temperature digital display in degrees Fahrenheit 1010 and food temperature digital display in degrees Celsius 1020 can be seen by users with hearing impairments. In another embodiment, the temperature readings in degrees Fahrenheit and degrees Celsius may be electronic vocalizations using a text reader. This feature can be configured to broadcast the electronic vocalizations in languages selected by the user using the food warming system digital application of one embodiment.

The watertight power bank cover 600 of FIG. 7A includes a watertight seal 712 of FIG. 7A where battery attaches to Oring. Outer battery casing is sealed, waterproof plastic, when mounted with watertight seal 712 of FIG. 7A, it becomes a waterproof battery attachment. A wireless charging receiver may be embedded into the battery in one embodiment to allow the battery to be charged via wireless system of one embodiment.

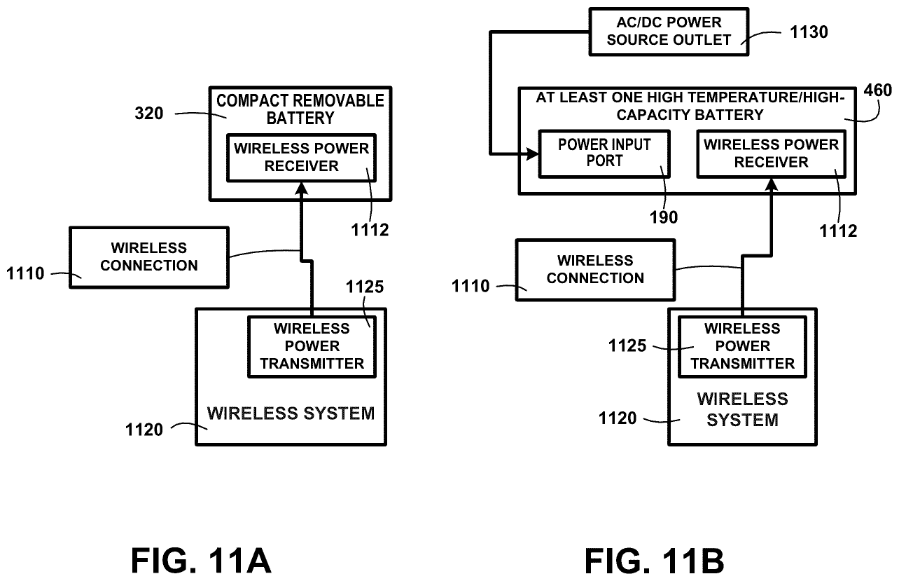

FIG. 11A shows for illustrative purposes only an example of a wireless system of one embodiment. FIG. 11A shows a wireless power receiver 1112 embedded into a compact removable battery 320. The wireless power receiver 1112 receives power from a wireless connection 1110 to a wireless power transmitter 1125 of the wireless system 1120. The wireless connection 1110 is a magnetic resonant coupling of one embodiment.

FIG. 11B shows for illustrative purposes only an example of recharging systems of one embodiment. FIG. 11B shows at least one high temperature/high-capacity battery 460 electrically connected from an AC/DC power source outlet 1130 to the power input port 190 plug-in to recharge the at least one high temperature/high-capacity battery 460.

The at least one high temperature/high-capacity battery 460 also has in one embodiment a wireless power receiver 1112 that makes a wireless connection 1110 to a wireless power transmitter 1125 of a wireless system 1120 to recharge the at least one high temperature/high-capacity battery 460.

Additionally, a conventional AC or DC power supply may not be readily available, for example, while hiking. Hot food and beverages are a necessity in some cases in cold weather conditions. Having wireless system 1120 for recharging the at least one high temperature/high-capacity battery 460 ensures an extendable power supply of one embodiment.

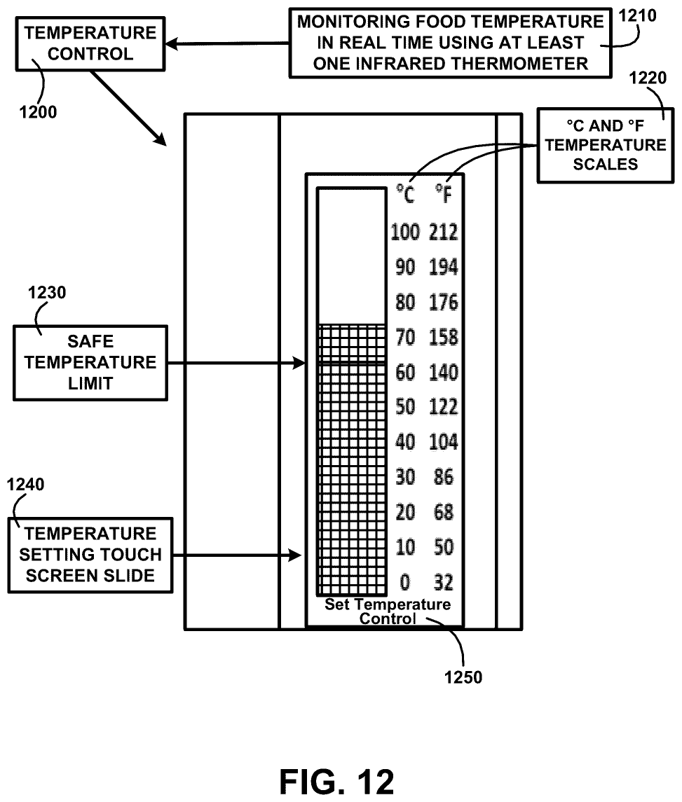

FIG. 12 shows for illustrative purposes only an example of a temperature control of one embodiment. FIG. 12 shows a temperature control 900 panel display showing the current temperature and allows a user to adjust the temperature. The temperature control 900 is also used for monitoring food temperature in real time using at least one no-contact infrared thermometer 1210. The temperature control 900 displays both ° C. and ° F. temperature scales 1220 and a safe temperature limit 1230. The temperature control 900 includes a temperature setting touchscreen slide 1240 for a user to set temperature control 1250 temperatures. In another embodiment, the temperature control 900 includes digital touch buttons labeled for specific food types, for example, soups, sandwiches, stews, vegetables, and others.

The digital touch buttons labeled for specific food types when pressed will set the targeted temperature setting to preset temperatures prerecorded in one of the at least one database. The temperature control 900 is coupled to the control printed circuit board assembly. The temperature control 900 is configured for the user to set a temperature for warming the food placed in the food warming system. The temperature setting touch screen slide 1240 is adjustable using degrees Celsius and degrees Fahrenheit temperature scales of one embodiment.

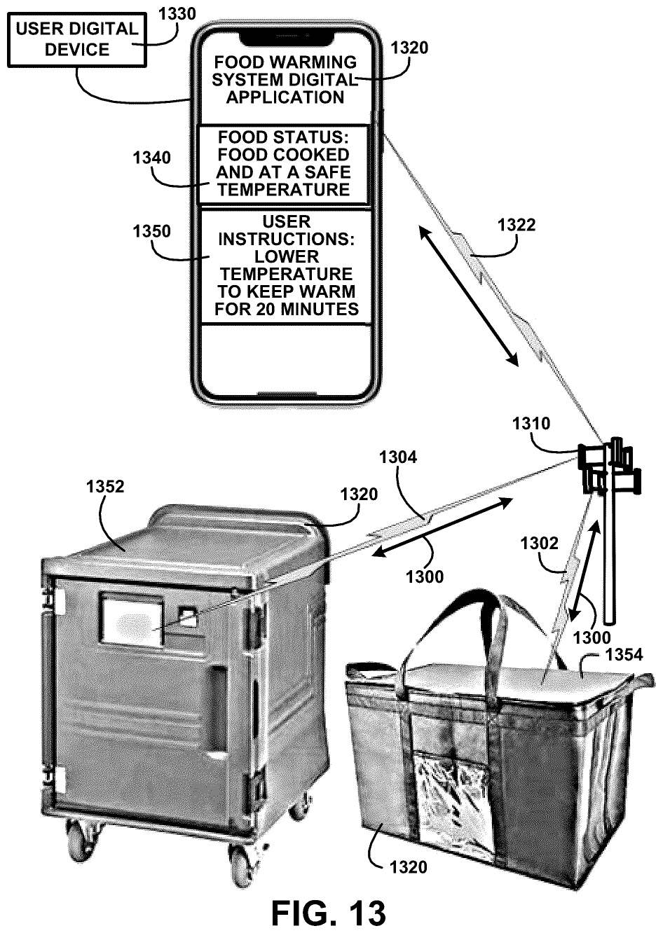

FIG. 13 shows for illustrative purposes only an example of a food warming system digital application of one embodiment. FIG. 13 shows transmitting food status information to a user and receiving user instructions from a user digital device 1330 using a food warming system digital application 1320. The soft-sided food transport container 1354 temperature control system is coupled to the food warming system digital application 1320 installed in the internal master PCBA 466 of FIG. 3. The hard-sided rolling food transport container 1352 temperature control system is coupled to the food warming system digital application 1320 installed in the internal master PCBA 466 of FIG. 3. The food warming system bidirectional communication 1300 allows food warming system digital application 1320 transmissions, for example, to a cell tower 1310, Bluetooth, and WIFI connection to a user digital device 1330.

The food warming system digital application 1320 includes the food warming system digital application bidirectional communication 1322. The food warming system digital application 1320 installed on the user's digital device 1330 will display a food status: food cooked and at a safe temperature 1340. The user can transmit 1302 to the soft-sided rolling food transport container 1354 temperature control system user instructions and receive food status audible and visual alert broadcast from the soft-sided rolling food transport container 1354. The user can transmit to the hard-sided rolling food transport container 1352 temperature control system user instructions and receive food status audible and visual alert broadcast from the hard-sided rolling food transport container 1352. In one instance, the user instructions can be to lower the temperature to keep warm for 20 minutes 1350 before they arrive at the food transport container 1352 of one embodiment.

The food system heat module includes a food warming system digital application for installation on a user's digital device including, for example, a smartphone, tablet, laptop computer, and other digital devices. The food warming digital application installed on a user's digital device is configured for displaying the food status alerts on a digital screen and broadcasting audible food status alerts. The user can tap the food warming digital application icon and receive intermediate food status alerts to check the current temperature and a calculated approximate time remaining for the food to reach a safe temperature. In one embodiment, the food warming digital application may display the temperature selection controls of the chafer transportable food warming module. This allows the user to set the desired temperature using the user's digital device. The user may want to turn off or adjust the temperature which they can perform using the food warming digital application of one embodiment.

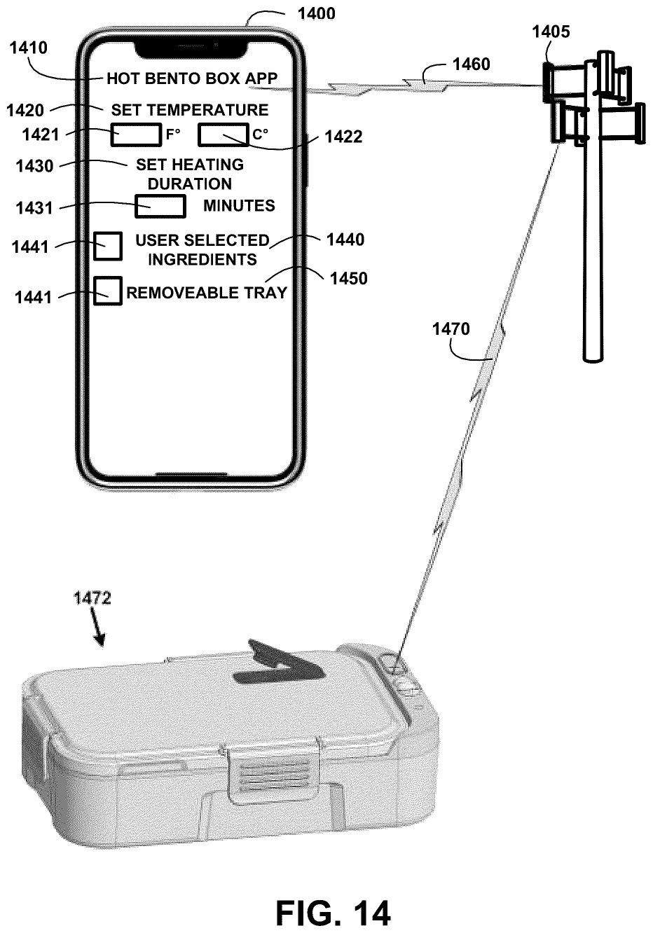

FIG. 14 shows for illustrative purposes only an example of a hot bento box app of one embodiment. FIG. 14 shows the waterproof bento box 1472 wirelessly connected for communication between the waterproof bento box and hot bento box app 1470. In one embodiment, a cellular tower 1405 provides the signal system for bidirectional communication with a hot bento box app 1460. In another embodiment, the signal system can be WIFI, RFID, NFC, and others.

A user digital device 1400 with the hot bento box app 1410 may be used to set temperature 1420. The user sets the temperature in F° 1421 with an option for C° 1422. The user may set the heating duration 1430 entering the number of minutes 1431. They may be heating user selected ingredients 1440 so indicating with the check box 1441. The user may optionally select a removable tray 1450 with a check box 1441. The hot bento box app 1460 as requested by the user may additionally provide stored recipes that can guide the user on temperatures, timing, and other aspects of heating their meal. The hot bento box app 1460 also provides location tracking, image and comment data upload/storage, and other features to assist the user of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A portable battery powered cooktop, comprising:
a heat plate located above a heating device of the portable battery powered cooktop;
a control printed circuit board assembly coupled to heating elements of the heating device located below the heat plate configured to regulate current and send the current to the heat plate via the heating elements;
at least one removable rechargeable battery pack with a heat resistance housing configured to withstand a predetermined operating temperature of the at least one removable rechargeable battery pack, wherein the at least one removable rechargeable battery pack is coupled to the control printed circuit board assembly via the heating elements;
a temperature control device coupled to the control printed circuit board assembly and configured to regulate a temperature of the heat plate;
wherein the control printed circuit board assembly is supplied portable power from the at least one removable rechargeable battery pack and configured to activate and control the temperature of the heating elements to generate heat levels up to and above 500° F. to the heat plate; and
a vented air buffer chamber located within the heating device and configured to dissipate heat between the heat plate and the at least one removable rechargeable battery pack.

2. The portable battery powered cook top of claim 1, further comprising a meal cover coupled to a heat resistant plastic housing configured to form a watertight seal and secure a removable meal tray in place with a mechanical gasket.

3. The portable battery powered cook top of claim 2, further comprising a plurality of cover clips configured to secure the meal cover to the heat resistant plastic housing.

4. The portable battery powered cook top of claim 1, further comprising an AC operation port coupled to the control printed circuit board assembly to supply AC power.

5. The portable battery powered cook top of claim 1, further comprising a food warming mobile application wirelessly coupled to the control printed circuit board assembly and configured to remotely control functions of the portable battery powered cook top.

6. The portable battery powered cook top of claim 1, further comprising a plurality of water resistant connection port covers coupled to a plurality of connection ports configured to prevent water and moisture from entering the plurality of connection ports to prevent electrical short circuits.

7. The portable battery powered cook top of claim 1, further comprising a removable meal tray coupled to the heat plate configured to at least one warm or cook food within the removable meal tray.

8. The portable battery powered cook top of claim 1, further comprising a housing encasing the portable battery powered cook top and a mounting bracket removably coupled to the housing and configured to be removably coupled to a mount of a transportation vehicle to allow at least one of heating or cooking of food while transporting the food in the transportation vehicle.

9. The portable battery powered cook top of claim 1, further comprising a mounting bracket removably coupled to a housing of the portable battery powered cook top and configured to allow cookware to be mounted directly to the mounting bracket.

10. A portable battery powered cook top, comprising:
a heat plate located above a heating device of the portable battery powered cooktop;
a control printed circuit board assembly coupled to heating elements of the heating device located below the heat plate configured to regulate current and send the current to the heat plate via the heating elements;
at least one removable rechargeable battery pack with a heat resistance housing configured to withstand an operating temperature of the at least one removable rechargeable battery pack up to 182° F., wherein the at least one removable rechargeable battery pack is coupled to the control printed circuit board assembly via the heating elements;
a meal cover coupled to the heat plate configured to secure a removable meal tray in place with a mechanical gasket;
a temperature control device coupled to the control printed circuit board assembly and configured to regulate a temperature of the heat plate;
wherein the control printed circuit board assembly is supplied portable power from the at least one removable rechargeable battery pack and configured to activate and control the temperature of the heating elements to generate heat levels up to and above 500° F. to the heat plate; and
a vented air buffer chamber located within the heating device and configured to dissipate heat between the heat plate and the at least one removable rechargeable battery pack.

11. The portable battery powered cook top of claim 10, further comprising a meal cover coupled to a heat resistant plastic housing configured to form a watertight seal and secure a removable meal tray in place with a mechanical gasket.

12. The portable battery powered cook top of claim 10, further comprising an AC operation port coupled to the control printed circuit board assembly to supply AC power.

13. The portable battery powered cook top of claim 10, further comprising a food warming mobile application wirelessly coupled to the control printed circuit board assembly and configured to remotely control functions of the portable battery powered cook top.

14. The portable battery powered cook top of claim 10, further comprising a removable meal tray coupled to the heat plate configured to at least one warm or cook food within the removable meal tray.

15. A portable battery powered cook top, comprising:
a heat plate located above a heating device of the portable battery powered cooktop;
a control printed circuit board assembly coupled to heating elements of the heating device located below the heat plate configured to regulate current and send the current to the heat plate via the heating elements;
at least one removable rechargeable battery pack with a heat resistance housing configured to withstand an operating temperature of the at least one removable rechargeable battery pack up to 182° F., wherein the at least one removable rechargeable battery pack is coupled to the control printed circuit board assembly via the heating elements;
an AC operation port coupled to the control printed circuit board assembly via a plurality of conductive contacts configured for alternative power supplies including by a direct AC connection;
a meal cover coupled to the heat plate configured to secure a removable meal tray in place with a mechanical gasket;
a temperature control device coupled to the control printed circuit board assembly and configured to regulate a temperature of the heat plate;
wherein the control printed circuit board assembly is supplied portable power from the at least one removable rechargeable battery pack and configured to activate and control the temperature of the heating elements to generate heat levels up to and above 500° F. to the heat plate; and
a vented air buffer chamber located within the heating device and configured to dissipate heat between the heat plate and the at least one removable rechargeable battery pack.

16. The portable battery powered cook top of claim 15, further comprising a plurality of cover clips configured to secure the meal cover to the heat resistant plastic housing.

17. The portable battery powered cook top of claim 15, further comprising a food warming mobile application wirelessly coupled to the control printed circuit board assembly and configured to remotely control functions of the portable battery powered cook top.

18. The portable battery powered cook top of claim 15, further comprising a removable meal tray coupled to the heat plate configured to at least one warm or cook food within the removable meal tray.

19. The portable battery powered cook top of claim 15, further comprising a housing encasing the portable battery powered cook top and a mounting bracket removably coupled to the housing and configured to be removably coupled to a mount of a transportation vehicle to allow at least one of heating or cooking of food while transporting the food in the transportation vehicle.

20. The portable battery powered cook top of claim 15, further comprising a mounting bracket removably coupled to the meal heating system configured for allowing cookware of various shapes and functions to be mounted directly to the cooking system, including fry pan, soup pot, wok, griddle, warming tray, and a variety of other cookware.
